(19) United States
(12) Patent Application Publication
(10) Pub. No.: US 2008/0313267 A1
(43) Pub. Date: Dec. 18, 2008

(54) OPTIMIZE WEB SERVICE INTERACTIONS VIA A DOWNLOADABLE CUSTOM PARSER

(75) Inventors: Vikram A. Desai, Wexford, PA (US); Sai Gopala Rathnam, Raleigh, NC (US)

Correspondence Address: IBM CORP. (WSM);c/o WINSTEAD SECHREST & MINICK P.C., P.O. BOX 50784, DALLAS, TX, 75201, US

(73) Assignee: International Business Machines Corporation, Armonk, NY (US)

(21) Appl. No.: 11/761,619

(22) Filed: Jun. 12, 2007

(51) Int. Cl. G06F 15/16

(52) U.S. Cl. 709/203

(57) ABSTRACT

A method, system and computer program product for optimizing web service interactions. A server receives a service request from a client, where the service request includes information that is used by the server to provide a customized parser to the client that allows optimal web service interactions. Upon the server providing a link to the client to download this customized parser, the client downloads the parser and embeds the parser into its runtime environment. The parser in the client is then able to receive and transmit communications from and to the server, respectively, in a most efficient manner. For example, the parser may reduce the size of the XML message size more considerably than compression algorithms. In another example, if the client and server communicate in different languages, the parser may translate the messages between the client and server so that the messages are understandable.

### TECHNICAL FIELD

The present invention relates to the field of web services, and more particularly to optimizing web service interactions via a downloadable custom parser.

### BACKGROUND INFORMATION

The World Wide Web Consortium (W3C), which is the main international standards organization for the World Wide Web, has defined a “web service” as a software system designed to support interoperable machine to machine interaction over a network. That is, web services may refer to web-based applications that interact with other web-based applications in order to provide a desired service. For example, application software on a user's desktop computer (e.g., Microsoft™ Money) may send messages via the Internet to a stock quote server in order to retrieve current stock quotes for selected stocks. The application software may then display the retrieved information within the application for the user. Other examples of common web services include banking, currency converters, airplane flight schedule lookups, auction services and language translation services.

As discussed above, a web service may refer to software system designed to support interoperable machine to machine interaction over a network. One machine may be referred to as the “client;” whereas the other machine may be referred to as the “server.” The client refers to the machine that requests a service; whereas, the server refers to the machine that provides the requested service. Typically, the client and server communicate with one another involving a web service using eXtensible Markup Language (XML) messages that follow the Simple Object Access Protocol (SOAP)-standard. SOAP was developed as a way for a program or other object running in one kind of operating system on one device to communicate with a program or other object in the same or another kind of an operating system on another device by using the World Wide Web's HyperText Transfer Protocol (HTTP) and XML as the mechanisms for information exchange. SOAP specifies exactly how to encode an HTTP header and an XML file so that a program in one computer can call a program in another computer and pass it information.

XML is used for defining data elements on a Web page and business-to-business documents. That is, XML defines what those data elements on a Web page and in business-to-business documents contain. A developer of a Web page may define what these elements contain via XML “tags” or “statements.” Hence, virtually any data item, such as a “product,” “sales rep” and “amount due,” can be identified, allowing Web pages to function like database records. These XML tags or statements are human-readable and are provided in a simple data format. An example of an XML statement is the following:

<firstName>Maria</firstName>
<lastName>Roberts</lastName>
<dateBirth>10-29-52</dateBirth>

While XML statements are easy to read and understand, XML statements tend to be verbose. Text-based XML document sizes tend to be large, in part because of the verbosity of the XML language and also because XML documents tend to include a lot of redundant data (e.g., white space, similar names). Hence, when the XML messages that follow the SOAP-standard are communicated between the client and the server in connection with web service interactions, the message payload is quite large thereby increasing the amount of time the client and server communicate between one another over a network.

As a result, these XML messages or packets are compressed using various compression algorithms to reduce the size of the message payload thereby improving the performance of network communications. However, these compression algorithms do not focus on the semantics of the XML messages. Instead, they simply focus on the application and network layers.

If, however, the semantics of the XML messages could be understood, then these compression algorithms could be better utilized to reduce the size of the message payload thereby improving the performance of network communications in connection with web services. Further, if the client and server could better understand one another (e.g., better understand the services requested by the client) in a more efficient manner (e.g., less communications), then network communications performance would further be improved.

Therefore, there is a need in the art for optimizing web service interactions, such as by reducing the size of the message payload as well as more effectively communicating between the clients and servers.

### SUMMARY

The problems outlined above may at least in part be solved in some embodiments by having the client involved in web service interactions download a parser that is customized by the server involved in the web service interactions. The downloaded parser may be customized by the server in such a manner that it ensures that both the client and server communicate with one another in the most efficient manner.

In one embodiment of the present invention, a method for optimizing web service interactions comprises the step of receiving a service request, where the service request comprises information regarding one or more of a speed of network communications, a processing speed and a type of platform. The method further comprises issuing a link to download a parser, where the parser is customized based on the information regarding one or more of the speed of network communications, the processing speed and the type of platform, where the customized parser is embedded in a runtime environment in a client.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE DRAWINGS

A better understanding of the present invention can be obtained when the following detailed description is considered in conjunction with the following drawings, in which:

FIG. 1 illustrates an embodiment of the present invention of a network system for implementing web services;

FIG. 2 illustrates a hardware configuration of a client involved in web service interactions in accordance with an embodiment of the present invention;

FIG. 3 illustrates a hardware configuration of a server involved in web service interactions in accordance with an embodiment of the present invention;

FIG. 4A illustrates a runtime environment of the client involved in web service interactions in accordance with an embodiment of the present invention;

FIG. 4B illustrates a runtime environment of the server involved in web service interactions in accordance with an embodiment of the present invention;

FIG. 5 is a flowchart of a method for optimizing web service interactions in accordance with an embodiment of the present invention; and

FIG. 6 is a flowchart of a method for updating a version of a parser embedded in the runtime environment of the client in accordance with an embodiment of the present invention.

### DETAILED DESCRIPTION

The present invention comprises a method, system and computer program product for optimizing web service interactions. In one embodiment of the present invention, a server receives a service request from a client, where the service request includes information that is used by the server to provide a parser to the client that allows optimal web service interactions. For example, the client may include information regarding the communication rate (e.g., communications in network link between client and server is slow) and the type of platform of the client. The parser provided by the server may be customized to optimize the communication rate as well as be compatible with the client's type of platform. Upon the server providing a link to the client to download this customized parser, the client downloads the parser and embeds the parser into its runtime environment. The parser in the client is then able to receive and transmit communications from and to the server, respectively, in a most efficient manner. For example, the parser may reduce the size of the XML message size more considerably than compression algorithms. In another example, if the client and server communicate in different languages, the parser may translate the messages between the client and server so that the messages are understandable.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

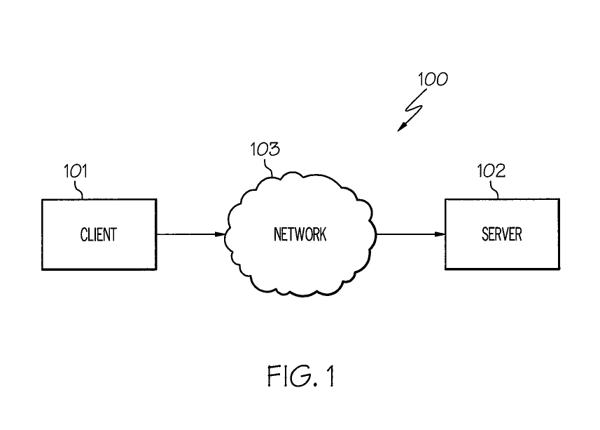

### FIG. 1—Network System for Web Services

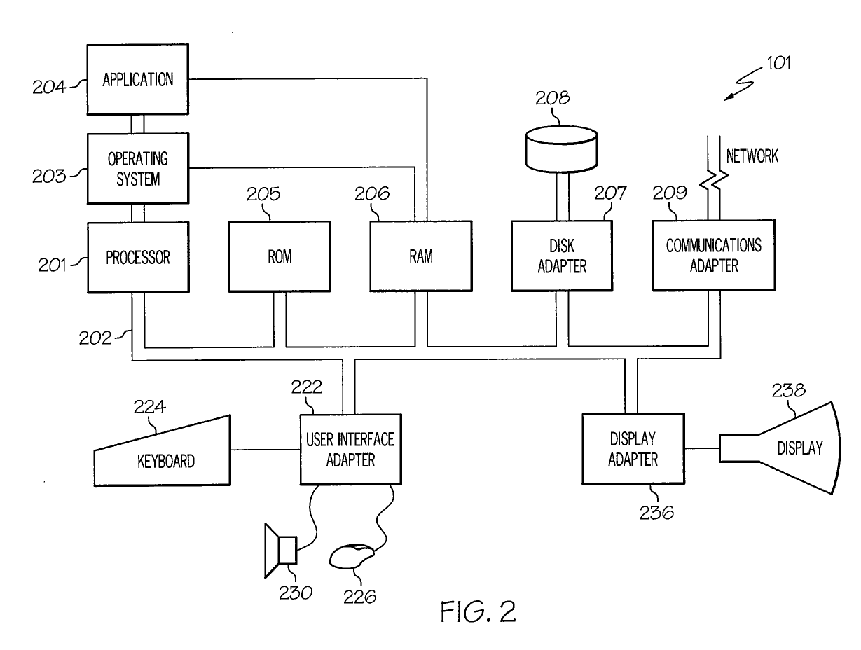

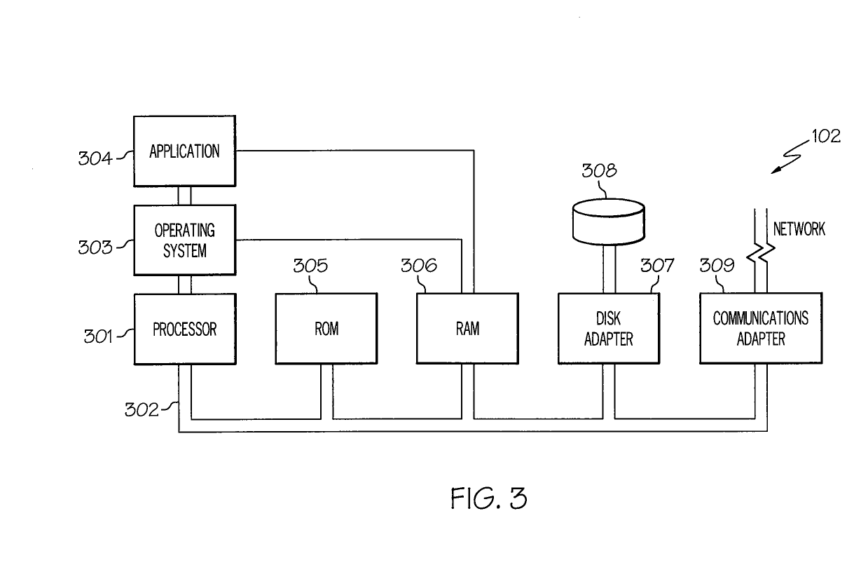

FIG. 1 illustrates an embodiment of a network system 100 for implementing web services in accordance with the present invention. Network system 100 may include a client 101 in communication with a server 102 via a network 103. Network 103 may be a Local Area Network (LAN) (e.g., Ethernet, Token Ring, ARCnet), or a Wide Area Network (WAN) (e.g., Internet). In the field of “web services,” client 101 may be referred to as a “service requester” and server 102 may be referred to as a “service provider.” Client 101 requests a service from server 102 using eXtensible Markup Language (XML) messages that follow the Simple Object Access Protocol (SOAP)-standard. For example, application software (e.g., Microsoft™ Money) on client 101 may send messages via network 103 to server 102 in order to retrieve current stock quotes for selected stocks. The application software on client 101 may then display the retrieved information within the application for the user of client 101. Other examples of common web services include banking, currency converters, airplane flight schedule lookups, auction services and language translation services. A more detail description of client 101 is provided below in connection with FIG. 2. Further, a more detail description of server 102 is provided below in connection with FIG. 3.

Referring to FIG. 1, the connection between client 101 and server 102 may be any medium type (e.g., wireless, wired). Further, client 101 may be any type of device (e.g., wireless, Personal Digital Assistant (PDA), cell phone, personal computer system, workstation, Internet appliance) configured with the capability of connecting to network 103 and consequently communicating with server 102. FIG. 1 is not to be limited in scope to any one particular embodiment.

### FIG. 2—Hardware Configuration of Client

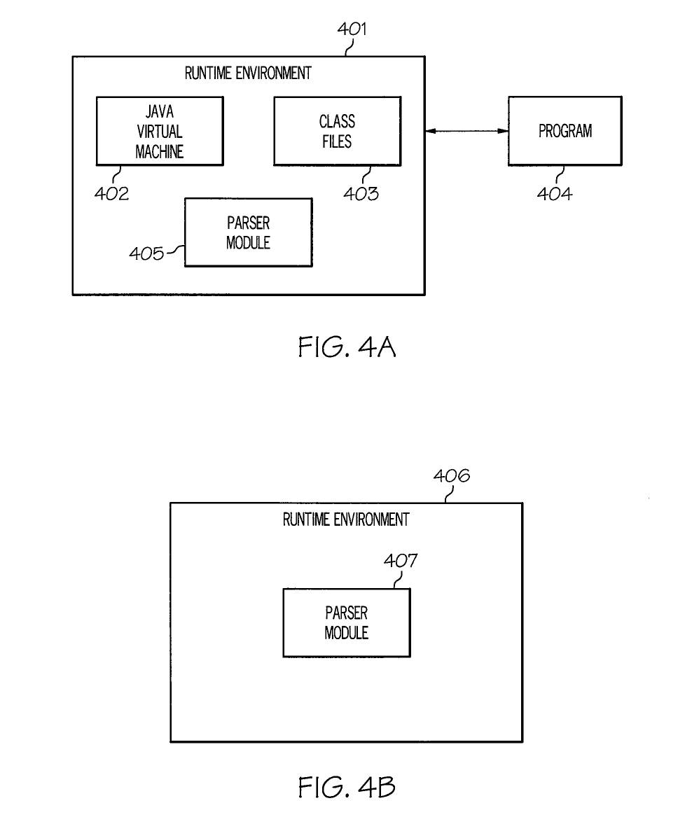

FIG. 2 illustrates an embodiment of a hardware configuration of client 101 (FIG. 1) which is representative of a hardware environment for practicing the present invention. Client 101 may have a processor 201 coupled to various other components by system bus 202. An operating system 203 may run on processor 201 and provide control and coordinate the functions of the various components of FIG. 2. An application 204 in accordance with the principles of the present invention may run in conjunction with operating system 203 and provide calls to operating system 203 where the calls implement the various functions or services to be performed by application 204. Application 204 may include, for example, a web browser, a runtime environment as discussed below in association with FIG. 4A, as well as a program (e.g., Microsoft™ Money) for requesting services from server 102 (FIG. 1).

Referring to FIG. 2, Read-Only Memory (ROM) 205 may be coupled to system bus 202 and include a basic input/output system (“BIOS”) that controls certain basic functions of client 101. Random access memory (RAM) 206 and disk adapter 207 may also be coupled to system bus 202. It should be noted that software components including operating system 203 and application 204 may be loaded into RAM 206, which may be client's 101 main memory for execution. Disk adapter 207 may be an integrated drive electronics (“IDE”) adapter that communicates with a disk unit 208, e.g., disk drive.

Referring to FIG. 2, client 101 may further include a communications adapter 209 coupled to bus 202. Communications adapter 209 may interconnect bus 202 with network 103 enabling client 101 to communicate with server 102.

I/O devices may also be connected to client 101 via a user interface adapter 222 and a display adapter 236. Keyboard 224, mouse 226 and speaker 230 may all be interconnected to bus 202 through user interface adapter 222. Data may be inputted to client 101 through any of these devices. A display monitor 238 may be connected to system bus 202 by display adapter 236. In this manner, a user is capable of inputting to client 101 through keyboard 224 or mouse 226 and receiving output from client 101 via display 238 or speaker 230.

The various aspects, features, embodiments or implementations of the invention described herein can be used alone or in various combinations. The methods of the present invention can be implemented by software, hardware or a combination of hardware and software. The present invention can also be embodied as computer readable code on a computer readable medium. The computer readable medium is any data storage device that can store data which can thereafter be read by a computer system. Examples of the computer readable medium include read-only memory, random access memory, CD-ROMs, flash memory cards, DVDs, magnetic tape, optical data storage devices, and carrier waves. The computer readable medium can also be distributed over network-coupled computer systems so that the computer readable code is stored and executed in a distributed fashion.

### FIG. 3—Hardware Configuration of Server

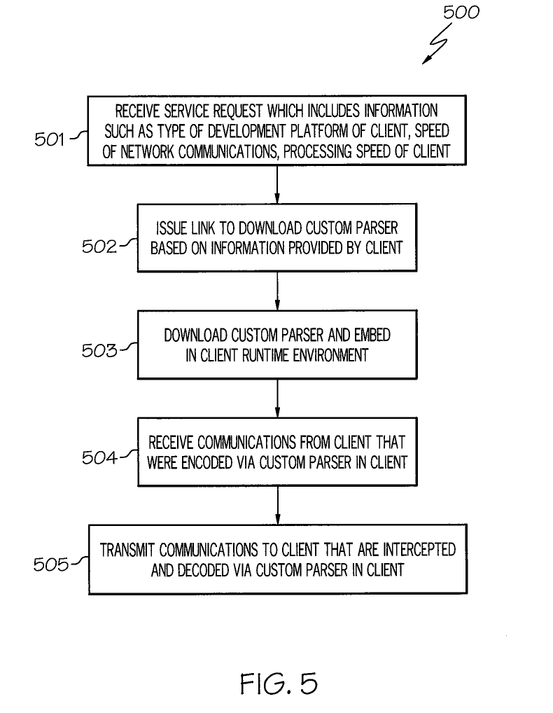

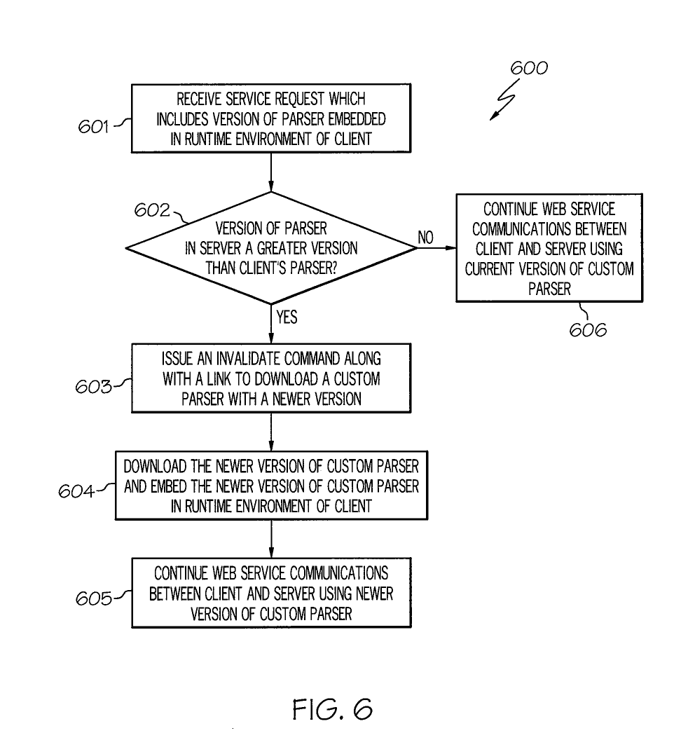

FIG. 3 illustrates a typical hardware configuration of a server 102 (FIG. 1) which is representative of a hardware environment for practicing the present invention. Server 102 may have a processor 301 coupled to various other components by system bus 302. An operating system 303 may run on processor 301 and provide control and coordinate the functions of the various components of FIG. 3. An application 304 in accordance with the principles of the present invention may run in conjunction with operating system 303 and provide calls to operating system 303 where the calls implement the various functions or services to be performed by application 304. Application 304 may include, for example, a runtime environment as discussed below in association with FIG. 4B, a program for optimizing web service interactions as discussed below in association with FIGS. 5-6.

Referring to FIG. 3, Read-Only Memory (ROM) 305 may be coupled to system bus 302 and include a basic input/output system (“BIOS”) that controls certain basic functions of server 102. Random access memory (RAM) 306 and disk adapter 307 may also be coupled to system bus 302. It should be noted that software components including operating system 303 and application 304 may be loaded into RAM 306, which may be server's 102 main memory for execution. Disk adapter 307 may be an integrated drive electronics (“IDE”) adapter that communicates with a disk unit 308, e.g., disk drive. It is noted that the program for optimizing web service interactions, as discussed below in association with FIGS. 5-6, may reside in disk unit 308 or in application 304.

Referring to FIG. 3, server 102 may further include a communications adapter 309 coupled to bus 302. Communications adapter 309 may interconnect bus 302 with a network 103 enabling server 102 to communicate with client 101.

The various aspects, features, embodiments or implementations of the invention described herein can be used alone or in various combinations. The methods of the present invention can be implemented by software, hardware or a combination of hardware and software. The present invention can also be embodied as computer readable code on a computer readable medium. The computer readable medium is any data storage device that can store data which can thereafter be read by a computer system. Examples of the computer readable medium include read-only memory, random access memory, CD-ROMs, flash memory cards, DVDs, magnetic tape, optical data storage devices, and carrier waves. The computer readable medium can also be distributed over network-coupled computer systems so that the computer readable code is stored and executed in a distributed fashion.

As discussed in the Background Information section, clients and servers communicate with one another involving a web service using XML messages. XML statements are easy to read and understand, however, XML statements tend to be verbose. Hence, when the XML messages are communicated between the client and the server, the message payload is quite large thereby increasing the amount of time the client and server spend in communicating between one another over a network. As a result, these XML messages or packets are compressed using various compression algorithms to reduce the size of the message payload thereby improving the performance of network communications. However, these compression algorithms do not focus on the semantics of the XML messages. Instead, they simply focus on the application and network layers. If, however, the semantics of the XML messages could be understood, then these compression algorithms could be better utilized to reduce the size of the message payload thereby improving the performance of network communications in connection with web services. Further, if the client and server could better understand one another (e.g., better understand the services requested by the client) in a more efficient manner (e.g., less communications), then network communications performance would further be improved. Therefore, there is a need in the art for optimizing web service interactions, such as by reducing the size of the message payload as well as more effectively communicating between the clients and servers. Web service interactions may at least in part be improved by having a customized parser downloaded by the client in response to a request from the server as discussed below in association with FIGS. 4A-B, 5 and 6. FIG. 4A illustrates a runtime environment of client 101 which includes an embedded parser downloaded by client 101. FIG. 4B illustrates the runtime environment of server 102. FIG. 5 is a flowchart of a method for optimizing web service interactions. FIG. 6 is a flowchart of a method for updating the version of the parser embedded in the runtime environment of client 101.

### FIG. 4A—Runtime Environment of Client

FIG. 4A illustrates a runtime environment 401 of client 101 (FIGS. 1-2) in accordance with an embodiment of the present invention. Referring to FIGS. 1-3, in conjunction with FIG. 4A, runtime environment 401 may refer to software (e.g., application 204 in FIG. 2) which provides software services for processes or programs while client 101 is running. An example of runtime environment 401 is a Java™ runtime environment which allows client 101 to run a Java™ application. Typically, a Java™ runtime environment includes a Java™ virtual machine 402 and standard class libraries 403 as illustrated in FIG. 4A. Java™ virtual machine 402 may refer to software that converts the Java™ intermediate language (“bytecode”) into machine language and executes it.

As stated above, in the example of runtime environment 401 being a Java™ runtime environment, runtime environment 401 includes components (e.g., Java™ virtual machine 402 and standard class libraries 403) that are required to run a Java™ program, such as program 404. For example, referring to FIG. 4A, the Java™ program 404 (e.g., application 204 in FIG. 2) may be a program (e.g., Microsoft™ Money) for requesting services from server 102.

As discussed above, there is a need in the art for optimizing web service interactions, such as by reducing the size of the message payload as well as more effectively communicating between the clients and servers. Web service interactions between client 101 and server 102 can be improved by having client 101 download a parser 405 (referred to as a “parser module”) from a link provided by server 102. Parser 405 may refer to a software routine that analyzes a continuous flow of data and breaks the data into its constituent parts. Parser 405 is able to abstract the semantic expressions of XML messages thereby reducing the message size further than compression algorithms. For example, suppose an XML message contained the following XML fragment:

```
<address>
    <street>11 Stanwix Street</street>
    <city>Pittsburgh</city>
    <zipCode>15222</zipCode>
</address>
```

If parser 405 is customized (discussed further below), web service communications, including XML messages, can be provided in a more efficient manner. For example, parser 405 could be customized to provide an address data type of an XML message such that the elements within the data type are delimited by “*.” As an example, parser 405 could encode the above-illustrated XML fragment as shown below:

<address>11 Stanwix Street*Pittsburgh*15222</address>

As illustrated, the message size is reduced considerably.

As discussed above, client 101 downloads parser 405 from a link provided by server 102. The link may direct client 101 to download the specified parser from either server 102 or a third party. The parser specified by server 102 is customized based on information provided by client 101 to server 102. For example, client 101 may indicate in its initial service request to server 102 that client's 101 development platform is a .NET platform. Parser 405 provided to client 101 would then be a .NET version. Further, client 101 may indicate in its initial service request to server 102 that communications in the network link between client 101 and server 102 is slow. Parser 405 provided by server 102 may then be customized to optimize the communication rate.

Parser 405 may be customized to ensure that both client 101 and server 102 communicate in an efficient manner as illustrated in the following examples. For example, if client 101 and server 102 communicate in different languages, parser 405 could perform language conversion, both on the messages being received from server 102 as well as on the messages being sent to server 102. Further, parser 405 could add additional information to the message payload being transmitted to thereby facilitate serviceability of the web services. For example, the additional information could be specific information related to client's runtime environment 401 that client 101 chooses to expose that could help serviceability, especially debugging issues that could arise due to some message incompatibility related to client runtime environment 401. Hence, “customizing” in connection with parser 405 refers to server 102 providing a parser that is most efficient in web service communications between client 101 and server 102.

Once client 101 downloads parser 405, parser 405 may be cached in runtime environment 401 only for the duration of the communications involved in the web service request or may be cached in runtime environment 401 until an updated parser 405 replaces the cached parser 405.

In one embodiment, parser 405 provided by server 102 is digitally signed to provide additional security. The runtime environment for server 102 will now be discussed below.

### FIG. 4B—Runtime Environment of Server

FIG. 4B illustrates a runtime environment 406 of server 102 (FIGS. 1 and 3) in accordance with an embodiment of the present invention. Referring to FIGS. 1-3, in conjunction with FIG. 4B, runtime environment 406 may refer to software (e.g., application 304 in FIG. 3) which provides software services for processes or programs while server 102 is running. Runtime environment 406 may include a parser 407 (referred to as a “parser module”) that may be configured similarly as parser 405 in runtime environment 401 of client 101.

In one embodiment, server 102 may be configured to compare the version of parser 405 with the version of parser 407 to ensure that parser 405 is the latest version and hence ensure that web service interactions between client 101 and server 102 is optimized. A more detail description of server 102 comparing the version of parser 405 with the version of parser 407 is provided below in connection with FIG. 6.

A method for optimizing web service interactions between client 101 and server 102 based on client's 101 use of parser 405 will now be discussed below in association with FIG. 5.

### FIG. 5—Method for Optimizing Web Service Interactions

FIG. 5 is a flowchart of a method 500 for optimizing web service interactions in accordance with an embodiment of the present invention.

Referring to FIG. 5, in conjunction with FIGS. 1-4, in step 501, server 102 receives a service request (e.g., retrieve current stock quotes for selected stocks) from client 101. The “service request” as used herein may include information used by server 102 to provide an appropriate parser (“custom parser”) for client 101. For example, the service request may include the type of development platform (e.g., .NET platform) client 101 is operating. In another example, the service request may include the speed of the network communications (e.g., client 101 may inform server 102 that the network link is slow). In another example, the service request may include the processing speed of claim 101.

In step 502, server 102 issues a link to download a custom parser 405 based on the information provided by client 101 in step 501. As discussed above, server 102 provides a parser that is most efficient in web service communications between client 101 and server 102 based on various information provided by client (e.g., development platform of client 101, speed of network communications, etc.).

In step 503, client 101 downloads custom parser 405 and embeds the downloaded custom parser 405 in runtime environment 401 if client 101 has the ability to embed a parser. In one embodiment, client 101 downloads custom parser 405 directly from server 102. In another embodiment, client 101 downloads custom parser 405 from a third party (e.g., another server). In one embodiment, custom parser 405 is cached in runtime environment 401 only for the duration of communications with server 102 involved in the web service request. In another embodiment, custom parser 405 is cached in runtime environment 401 until server 102 provides a link for an updated version as discussed further below in connection with FIG. 6.

In step 504, server 102 receives communications (referring to web service communications that include XML messages that follow the SOAP-standard) from client 101 that were encoded via custom parser 405. As discussed above, custom parser 405 may encode XML messages in such a way as to improve web service interactions, such as by reducing the size of the XML messages. Further, custom parser 405 may perform language conversion on the XML messages so as to be understandable to server 102. Further, custom parser 405 could add additional information to the message payload being transmitted to thereby facilitate serviceability of the web services. For example, the additional information could be specific information related to client runtime environment 401 that client 101 chooses to expose that could help serviceability, especially debugging issues that could arise due to some message incompatibility related to client runtime environment 401.

In step 505, server 102 transmits communications to client 101 that are intercepted and decoded by customer parser 405. Parser 405 may decode these communications in such a manner that the communications between server 102 and client 101 is more efficient (e.g., perform language conversion on the communications so as to be understandable to client 101).

Method 500 may include other and/or additional steps that, for clarity, are not depicted. Further, method 500 may be executed in a different order presented and that the order presented in the discussion of FIG. 5 is illustrative. Additionally, certain steps in method 500 may be executed in a substantially simultaneous manner or may be omitted.

As discussed above, parser 405 downloaded by client 101 may be cached in runtime environment 401 until a newer version is provided by server 102. A more detail discussion of providing a newer version of parser 405 is provided below in association with FIG. 6.

### FIG. 6—Method for Updating Version of Parser Embedded in Runtime Environment of Client

FIG. 6 is a flowchart of a method 600 for updating the version of parser 405 (FIG. 4A) embedded in runtime environment 401 (FIG. 4A) of client 101 (FIGS. 1 and 2) in accordance with an embodiment of the present invention.

Referring to FIG. 6, in conjunction with FIGS. 1-4, in step 601, server 102 receives a service request (e.g., retrieve current stock quotes for selected stocks) from client 101. The “service request” may include information regarding the version of parser 405 embedded in runtime environment 401.

In step 602, server 102 compares the version of parser 405 provided in the received service request with the version of parser 407 in runtime environment 406 of server 102.

If the version of parser 407 in runtime environment 406 of server 102 is greater than the version of parser 405 provided in the received service request, then, in step 603, server 102 issues an invalidate command along with a link to download a newer version of custom parser 405.

In step 604, client 101 downloads the newer version of custom parser 405 and embeds the newer version of custom parser 405 in runtime environment 401. In one embodiment, client 101 downloads the newer version of custom parser 405 directly from server 102. In another embodiment, client 101 downloads the newer version of custom parser 405 from a third party (e.g., another server).

In step 605, server 102 continues web service communications, as discussed herein, with client 101 using the newer version of custom parser 405.

Referring to step 602, if, however, the version of parser 407 in runtime environment 406 of server 102 is not greater than the version of parser 405 provided in the received service request, then, in step 606, server 102 continues web service communications, as discussed herein, with client 101 using the current version of custom parser 405.

Method 600 may include other and/or additional steps that, for clarity, are not depicted. Further, method 600 may be executed in a different order presented and that the order presented in the discussion of FIG. 6 is illustrative. Additionally, certain steps in method 600 may be executed in a substantially simultaneous manner or may be omitted.

Although the method, system and computer program product are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims. It is noted that the headings are used only for organizational purposes and not meant to limit the scope of the description or claims.

1. A method for optimizing web service interactions comprising the steps of:
receiving a service request, wherein said service request comprises information regarding one or more of a speed of network communications, a processing speed and a type of platform; and
issuing a link to download a parser, wherein said parser is customized based on said information regarding one or more of said speed of network communications, said processing speed and said type of platform, wherein said customized parser is embedded in a runtime environment in a client.

2. The method as recited in claim 1 further comprising the step of:
receiving communications from said client that are encoded via said customized parser in said client.

3. The method as recited in claim 2, wherein said customized parser in said client reduces a size of eXtensible Markup Language (XML) messages.

4. The method as recited in claim 2, wherein said customized parser adds additional information to an eXtensible Markup Language (XML) message payload to facilitate serviceability of web services.

5. The method as recited in claim 1 further comprising the step of:
transmitting communications to said client that are decoded via said customized parser in said client.

6. The method as recited in claim 1, wherein said customized parser adds information dynamically to messages sent by said client.

7. The method as recited in claim 1, wherein said customized parser transforms messages sent by said client into a language understandable by a server receiving said service request.

8. The method as recited in claim 1, wherein said customized parser is embedded in said runtime environment in said client for the duration of communication with a server receiving said service request.

9. A method for optimizing web service interactions comprising the steps of:
receiving a service request, wherein said service request comprises information regarding a version of a parser embedded in a runtime environment in a client, wherein said parser was customized based on information regarding one or more of a speed of network communications, a processing speed and a type of platform of said client; and
issuing a link to download an updated version of said parser if a version of a parser in a server receiving said service request is greater than said version of said parser communicated in said service request.

10. The method as recited in claim 9 further comprising the step of:
issuing an invalidate command if said version of said parser in said server receiving said service request is greater than said version of said parser communicated in said service request.

11. A system, comprising:
a memory unit for storing a computer program for optimizing web service interactions;
a processor coupled to said memory unit, wherein said processor, responsive to said computer program, comprises:
circuitry for receiving a service request, wherein said service request comprises information regarding one or more of a speed of network communications, a processing speed and a type of platform; and
circuitry for issuing a link to download a parser, wherein said parser is customized based on said information regarding one or more of said speed of network communications, said processing speed and said type of platform, wherein said customized parser is embedded in a runtime environment in a client.

12. The system as recited in claim 11, wherein said processor further comprises:
circuitry for receiving communications from said client that are encoded via said customized parser in said client.

13. The system as recited in claim 11, wherein said processor further comprises:
circuitry for transmitting communications to said client that are decoded via said customized parser in said client.

14. The system as recited in claim 11, wherein said customized parser adds information dynamically to messages sent by said client.

15. The system as recited in claim 11, wherein said customized parser transforms messages sent by said client into a language understandable by a server receiving said service request.

16. A computer program product embodied in a computer readable medium for optimizing web service interactions comprising the programming steps of:
receiving a service request, wherein said service request comprises information regarding one or more of a speed of network communications, a processing speed and a type of platform; and
issuing a link to download a parser, wherein said parser is customized based on said information regarding one or more of said speed of network communications, said processing speed and said type of platform, wherein said customized parser is embedded in a runtime environment in a client.

17. The computer program product as recited in claim 16 further comprising the programming step of:
receiving communications from said client that are encoded via said customized parser in said client.

18. The computer program product as recited in claim 16 further comprising the programming step of:
transmitting communications to said client that are decoded via said customized parser in said client.

19. The computer program product as recited in claim 16, wherein said customized parser adds information dynamically to messages sent by said client.

20. The computer program product as recited in claim 16, wherein said customized parser transforms messages sent by said client into a language understandable by a server receiving said service request.
